(19) United States
(12) Patent Application Publication
(10) Pub. No.: US 2010/0177309 A1
(43) Pub. Date: Jul. 15, 2010

(54) MODULAR SPECTROSCOPY LABORATORY

(76) Inventors: Juan C. Scaiano, Ottawa (CA); Chris Genereux, Orleans (CA); Sharlene Hoftyzer, Ottawa (CA)

Correspondence Address: HESPOS & PORCO LLP, 110 West 40th Street, Suite 2501, NEW YORK, NY, 10018, US

(21) Appl. No.: 12/594,370

(22) PCT Filed: Apr. 7, 2008
(86) PCT No.: PCT/CA2008/000616

§ 371 Date: Mar. 24, 2010

Related U.S. Application Data
(60) Provisional application No. 60/910,305, filed on Apr. 5, 2007.

(30) Foreign Application Priority Data
Apr. 5, 2007 (CA) 2,584,085

(51) Int. Cl. G01J 3/12; G01J 3/45; G01J 1/58; G01J 3/42

(52) U.S. Cl. 356/319; 356/451; 356/331; 250/458.1; 356/244

(57) ABSTRACT

A modular spectroscopy laboratory (MSL), comprises a rigid case with a flashlamp rotatably mounted in said case. A sample holder is provided for holding a sample of solution for analysis, and a spectrometer is optically connected to the sample holder. The flashlamp is positionable at least two angles relative to the sample holder.

The present invention relates to the field of spectroscopy and provides a modular spectroscopic laboratory, herein, MSL. Moreover, as used herein, the term MSL indicates a new type of spectroscopic instrumentation capable of the seamless integration of hardware, software and user interface of a wide range of spectroscopic techniques, which at the present time include absorbance, fluorescence, fluorescence excitation, diffuse reflectance, spectroradiometry, thin film analysis (interferometry), chemiluminescence, bioluminescence, stopped flow and near-infrared detection.

### BACKGROUND

The present invention was conceived as an innovation in spectroscopy instrumentation. The basic premise is that while a number of spectroscopic measurements are available individually on the market, using individual products for each measurement results in duplication of optics and other components which could be eliminated by the development of an integrated, modular instrument. The concept of a Modular Spectroscopy Laboratory (MSL) is an enabling technology that allows a single expandable hardware platform, a single user interface, and a single software package to perform many different spectroscopic measurements. The MSL is expandable to incorporate measurements that were not part of an instrument as initially constructed and delivered, or even that were developed or invented at a later time. While individually each of the measurements currently enabled is available from one or more commercial suppliers, and occasionally two measurements are integrated in the same instrument, integrating three or more types of measurements using shared components and software is a novel technology.

The MSL of the present invention includes a range of capabilities for a plurality of different types of measurements where users can choose which combinations suit their needs and where new capabilities can be added with a small change to peripheral hardware and activation of the related software. Table 1 below summarizes these capabilities.

The applicant is not aware of any instrument manufacturer that has developed instrumentation with the broad capabilities available in MSL products. Thus the key to the present invention is not in each capability but rather in the overall range of two, three or more user-selected capabilities that MSL offers in a single platform and with a common user interface. Such a wide range of measurement types on a single platform and with software capable of using multiple algorithms and controlling a multiplicity of internal devices, most of them specific to a given technique, yet making the complexity transparent to users, is unique. Furthermore the MSL is able to make ‘intelligent’ decisions on a range of techniques with very different technical requirements is not available in any current technology.

To fully combine such a broad range of technical capabilities in a manner that is seamless to the user requires an integrated software platform managing all capabilities. The MSL software controls all aspects of the hardware and data management such that total integration of all available measurement is achievable.

This integration operates at three levels:
MSL-lab Allows data acquisition, manipulation of instrument devices, and selection of capabilities used. i.e., includes hardware interface. Some of the capabilities that are used in other MSL software modules (e.g. file import from other instruments) are also available in this module. MSL-lab includes hardware and software and can operate as a stand-alone instrument.
MSL-desk This software product allows data manipulation, including file import in a computer that is not connected to MSL hardware. Full data capabilities excluding data acquisition are available in this product. The product allows display, overlay, manipulation and calculation of data. This capability is unique to the MSL, since the norm in spectroscopic instrumentation is that manipulation is carried out at the instrument, or exported to general-use programs such as Excel. MSL-desk does not require hardware beyond the computer and includes full manipulation, import and export capabilities. MSL-desk in effect enhances the capabilities of MSL-lab by reducing or eliminating the need to invest instrument-time to analyze already acquired data. This software function is essential to the integration of techniques and the unique (multi-) functionality of the instrument because it allows multi-users or allows instrument time to be dedicated to data acquisition rather than data analysis.
MSL-net This is a server-type application allowing the viewing of MSL data from remote computers not having MSL software installed. It has limited functionality, but only requires a web browser. No specialized software required beyond web browser and internet connectivity are required. Capabilities include display, overlay and download of spectroscopic data This software function is essential to the integration of techniques and the unique (multi-) functionality of the instrument because it allows multi-users or allows instrument time to be dedicated to data acquisition rather than data analysis.
The capabilities of the present invention are described in table 1. Note that:
The capabilities accessible with the integration concepts of the MSL greatly exceed those listed in Table 1, which simply expresses those achievable with present hardware;
Capabilities are not limited to technologies available at present, but can be expanded to other spectroscopic methods that can be invented in the future, provided the spectral requirements (e.g., light sources) are already part of MSL's Master Unit, or can be added, either to the basic lab, or as an integrated peripheral;
Each of the techniques in Table one by itself does not constitute a new invention, but rather, the invention is based on the integration of multiple techniques in a single instrument. While some but not all pairs may be commercially available at present, three or more techniques in combination are not available. This invention relates to the technologies, microcontrollers, positioners, algorithms and software that through seamless integration allow multiple measurements to be performed within a single platform and user interface.

TABLE 1
MSL capabilities

| Module and function | Capability targets |
|---|---|
| WP2T1 | Range: 235 to 850 nm minimum |
| Spectroradiometer | Resolution ±1 nm |
| | Wavelength accuracy: ±1 nm (against Hg emission lines) |
| | Irradiance reference: Against solar radiation at AM1.5 |
| | (ASTM E892 standard). |
| | Can record maximum solar irradiance at ca. 480 nm |
| | (1.5 Wm⁻²nm⁻¹) using no |
| | more than one third of the detector saturation range |
| | (approx. 5000 counts, saturation is ca. 16,000 counts |
| | for USB4000 spectrometer) at integration times |
| | of not less than 10 ms. |
| | Dynamic range: minimum 10,000:1 |
| WP2T2 | Range: 210 to 850 nm minimum |
| UV-Vis | Resolution ±1 nm |
| spectrometer | Wavelength accuracy: ±1 nm (against Holmium filter lines) |
| | Sensitivity: minimum 0.002 absorbance units. |
| | Signal-to-noise: 100:1 on an absorbance of 0.1 at 260 nm |
| WP3T1 | Range: 240 to 850 ran minimum |
| Diffuse | Resolution ±1 nm |
| reflectance | Wavelength accuracy: ±1 nm (against Hg emission lines) |
| spectrometer | Sensitivity: minimum 0.5% reflectance change. |
| | Signal-to-noise: 100:1 on a reflectance of 20% at 300 nm |
| WP3T3 | Emission: |
| Emission | Range: 280 to 850 nm minimum |
| spectrometer | Resolution ±1 nm |
| (also referred | Wavelength accuracy: ±1 nm (against Hg emission lines) |
| as fluorescence | Signal-to-noise: 100:1 on Coumarin-6 emission |
| spectrometer) | Excitation (based on models with linear variable filter): |
| | Range: 230 to 750 nm |
| | Excitation bandwidth: 20 nm (depends on excitation wavelength) |
| WP3T3E | Excitation (based on models with linear variable filter): |
| Fluorescence | Range: 230 to 750 nm |
| excitation | Excitation bandwidth: 20 nm (depends on excitation wavelength) |
| spectroscopy | Data type: 3D data include excitation and emission |
| with the | simultaneous acquisition |
| Emission | Emission detection: |
| spectrometer | Range: 280 to 850 nm minimum |
| | Resolution ±1 nm |
| | Wavelength accuracy: ±1 nm (against Hg emission lines) |
| | Signal-to-noise: 100:1 on Coumarin-110 emission |
| WP4T1 | Range: 235 to 850 nm minimum |
| Chemi/bio- | Resolution ±1 nm |
| luminescence | Wavelength accuracy: ±1 nm (against Hg emission lines) |
| spectrometer | Irradiance sensitivity: At least 10⁻⁴ |
| | weaker against solar radiation at AM1.5 |
| | (ASTM E892 standard). Target sensitivity limit |
| | 1 μWm⁻²nm⁻¹ at 500 nm. |
| | Sensitivity test: Detection of in the luminol system with |
| | signal to noise better than 100:1 |
| WP4T2 | Standard: |
| NIR | Range: extension of normal range to 1050 nm in basic |
| spectroscopy | models, up to 1700 nm in advanced models |
| | Resolution ±1 nm with separate spectrometer. |
| | Wavelength accuracy: ±1 nm (against Didymium filter lines) |
| | Sensitivity: minimum 0.01 absorbance units. |
| | Signal-to-noise: 100:1 on an absorbance of 0.1 at 900 nm |
| | Extended: |
| | Same as above but with range extended to 1700 nm. This |
| | requires a special detector |
| WP6 | Range: 380 to 850 nm minimum |
| Thin film | Resolution ±1 nm |
| metrology | Wavelength accuracy: ±1 nm (against Hg emission lines) |
| | Film thickness range: 70 nm to 20 mm for films on a |
| | reflective or partially reflective (>2%) surface |
| WP7 | Range: 280 to 700 nm minimum (compliant with UPF guidelines) |
| Ultraviolet | Resolution ±1 nm |
| protection | Wavelength accuracy: ±1 nm (against Hg emission lines) |
| factor (UPF) for | Range of UPF values, from 0 to 60 (minimum) covering the |
| textile | range to MAXIMUM protection. |
| applications | |

Note that capabilities WP3T3 and WP3T3E correspond to different experimental measurements but utilize the same hardware configuration. Further, it is also expected that the MSL may integrate a stopped flow reaction module at a later date.

In a broad aspect, then, the present invention relates to an instrument consisting of light sources, wavelength selection hardware, shutters, liquid and solid sample holders, motorized positioners, light sensors (including ultraviolet, visible and near infrared spectrometers), optical components (such as lenses, prisms, filters, beam splitters and optical fibers), microprocessors, computer interfaces and software, capable of performing a wide range of spectroscopic measurements, selected from absorbance, transmittance, fluorescence, fluorescence excitation, diffuse reflectance, spectroradiometry, thin film analysis (interferometry), chemiluminescence, bioluminescence, stopped flow, ultraviolet protection factor (UPF), and near-infrared detection.

In another broad aspect, the present invention relates to a modular spectroscopy laboratory (MSL), comprising a rigid case, a flashlamp rotatably mounted in said case; a sample holder for holding a sample of solution for analysis, and a spectrometer optically connected to said sample holder; wherein said flashlamp is positionable at least two angles relative to said sample holder.

In the drawings that illustrate the present invention by way of example:

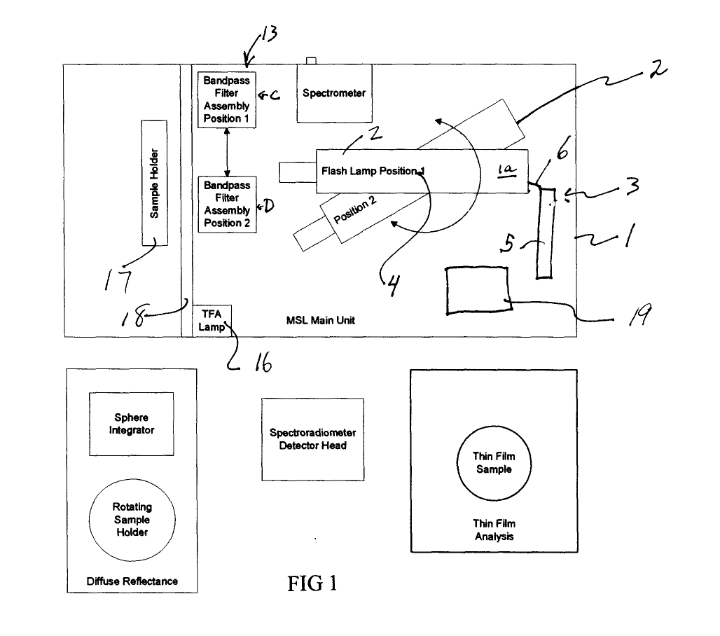

FIG. 1 is an overall plan diagram of the MSL of the present invention.

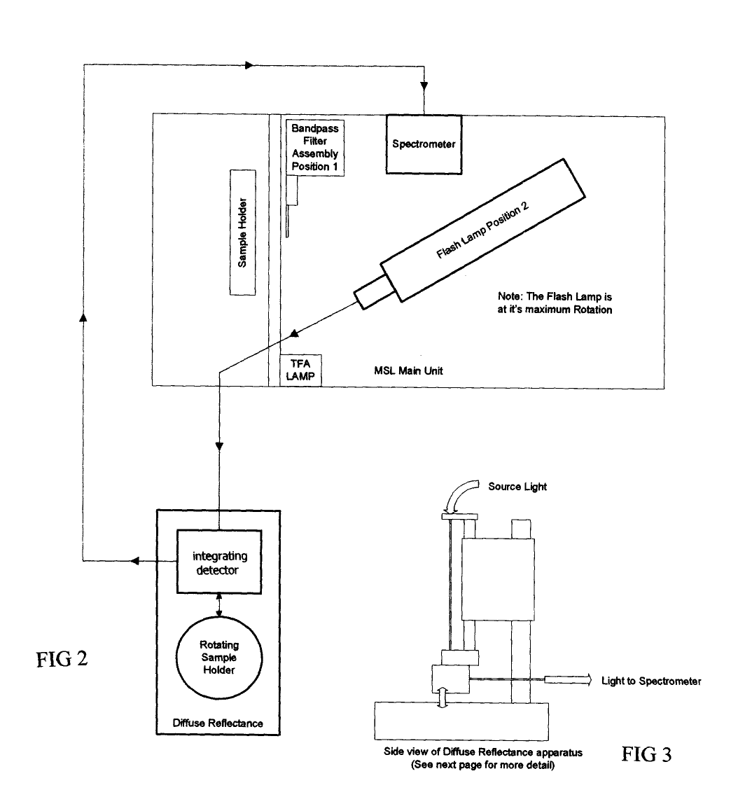

FIG. 2 is a diagram of the MSL of the present invention configured for a diffuse reflectance measurement.

FIG. 3 is a side view of a diffuse reflectance apparatus for use with the MSL of the present invention.

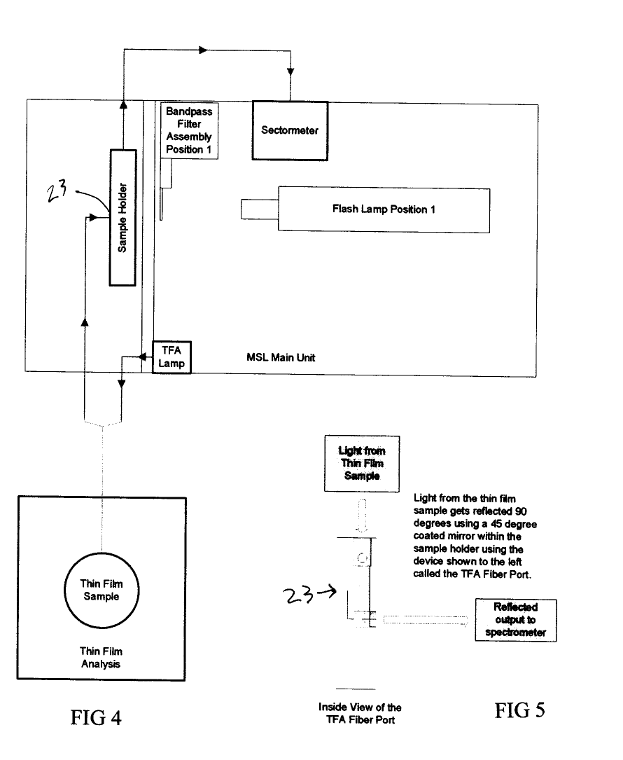

FIG. 4 is a diagram of the MSL of the present invention, configured for thin film analysis.

FIG. 5 is a detail view, partly in cross section of the thin film analysis fibre port provided in the sample holder of the present invention.

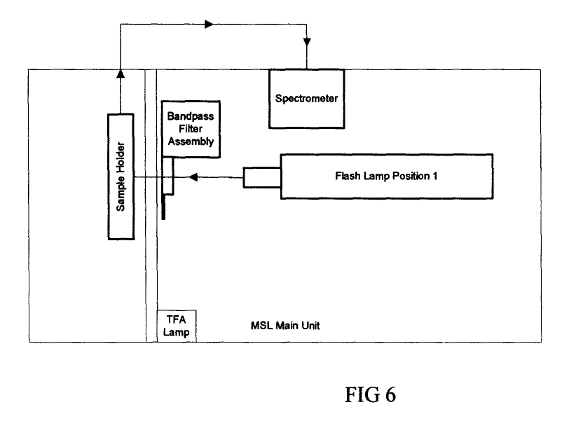

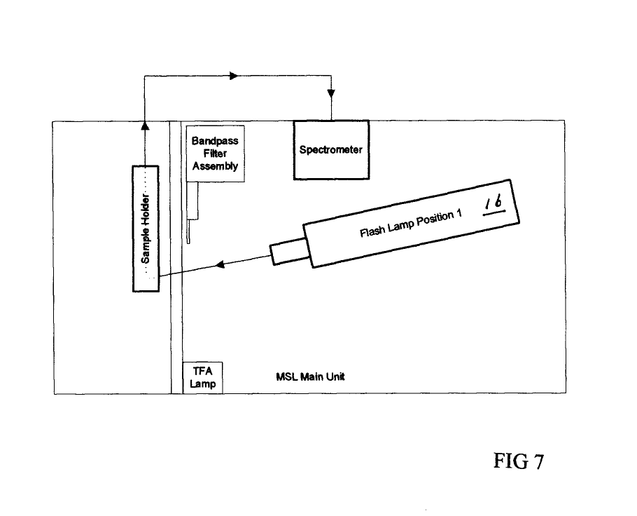

FIG. 6 is a diagram of the MSL of the present invention configured for fluorescence and fluorescence excitation measurement.

FIG. 7 is a diagram of the MSL of the present invention configured for absorbance measurement.

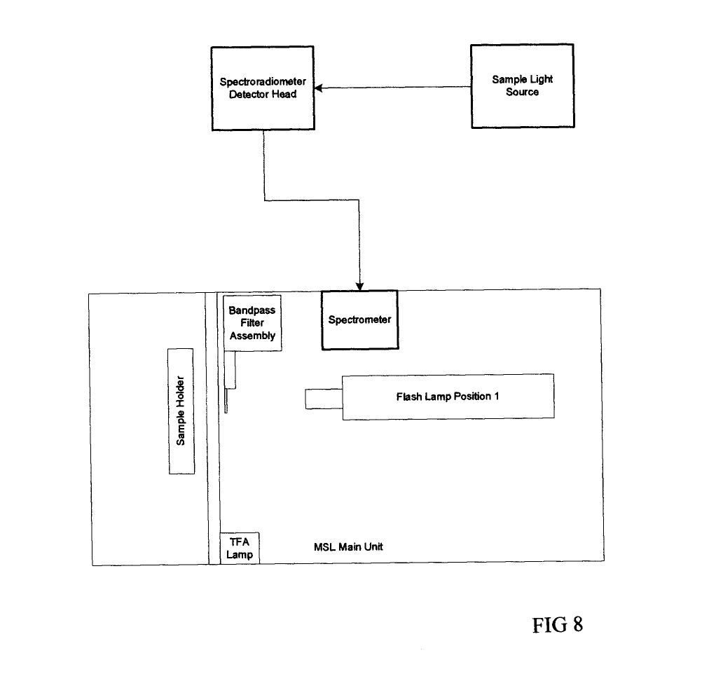

FIG. 8 is a diagram of the MSL of the present invention configured for spectroradiometry.

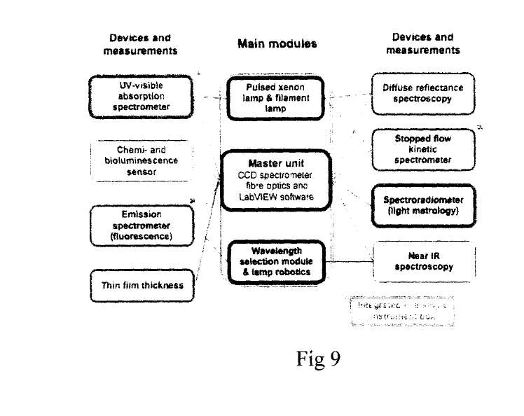

FIG. 9 is a chart illustrating main module components, and other devices and measurements associated with the MSL of the present invention.

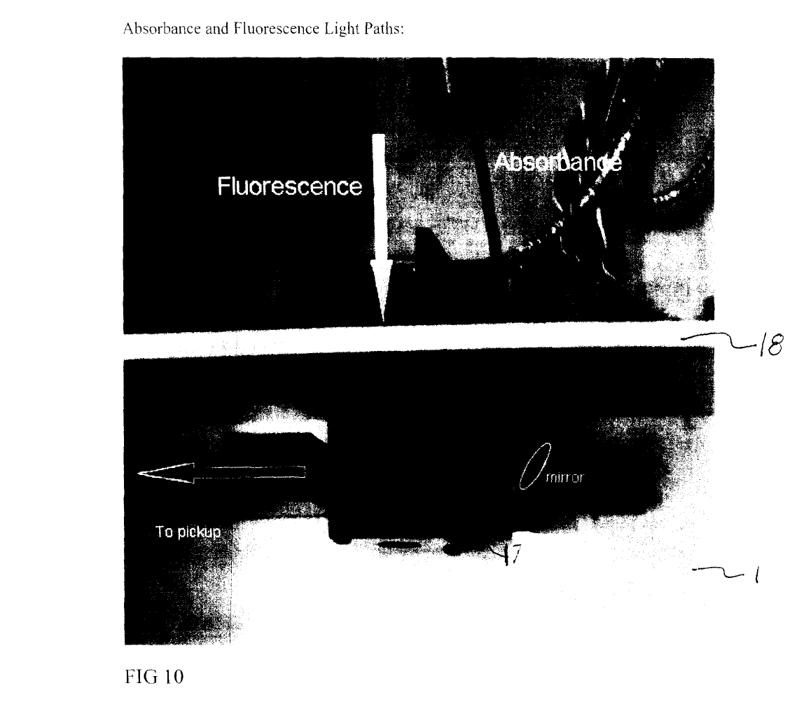

FIG. 10 is a plan view of a sample holder for use with the MSL of the present invention.

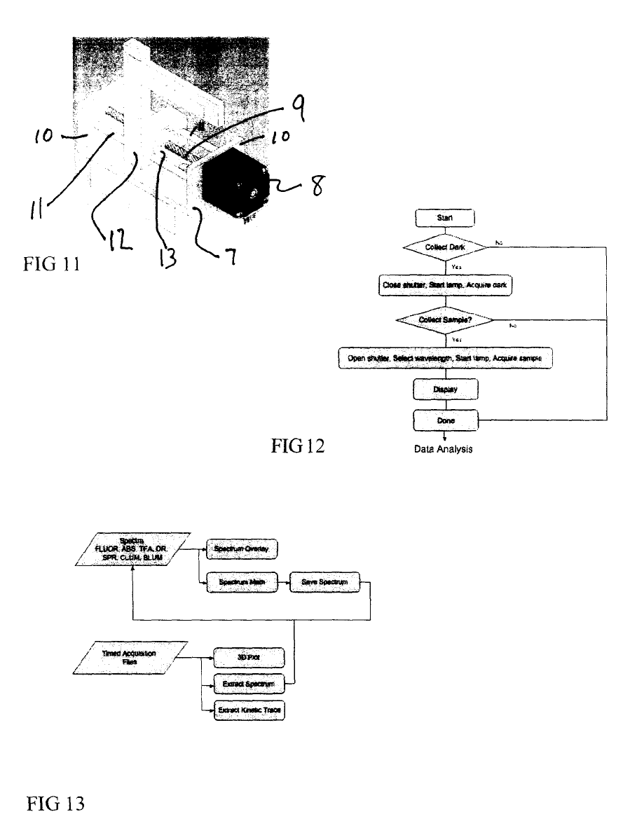

FIG. 11 is a perspective view of a filter holder and motor assembly used to select excitation wavelength.

FIG. 12 is an abbreviated software flow chart summarizing the sequence required for the acquisition of fluorescence spectrum.

FIG. 13 is a flow chart of data analysis and acquisition.

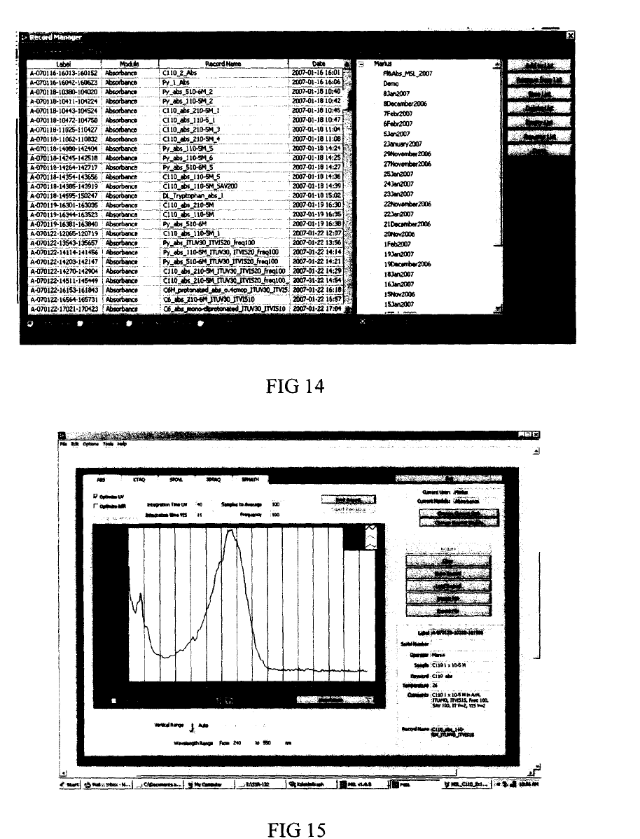

FIG. 14 is a screen capture of a user interface for the present invention.

FIG. 15 is a screen capture of an absorbance spectrum for C110 acquired for a 1×10⁻⁵ M solution.

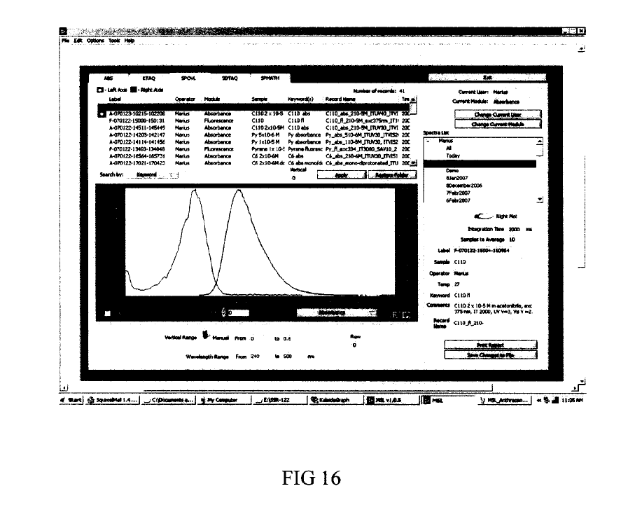

FIG. 16 is a screen capture of the absorbance and fluorescence spectra for C110 in a 2×10⁻⁵ solution.

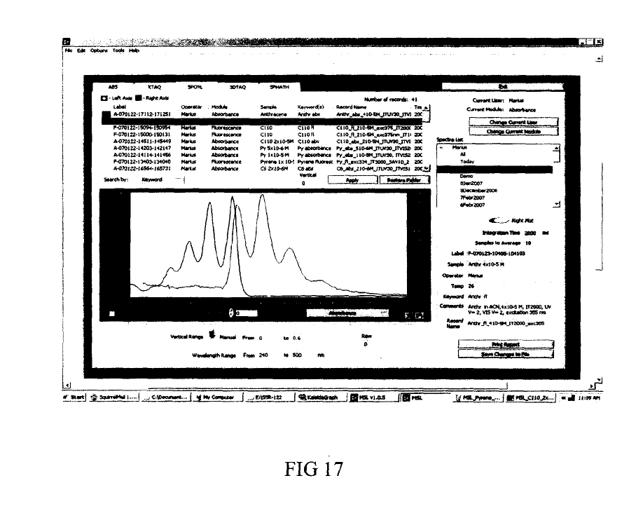

FIG. 17 is a screen capture of the absorbance and emission of anthracene in a 4×10⁻⁵ solution.

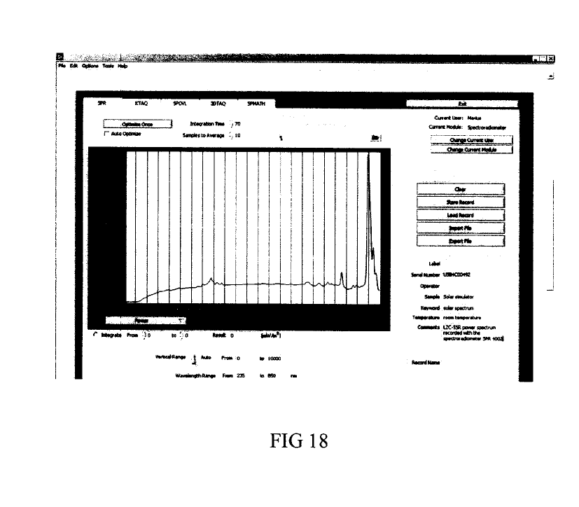

FIG. 18 is a screen capture of a spectrum corresponding to solar radiance in Ottawa, Canada.

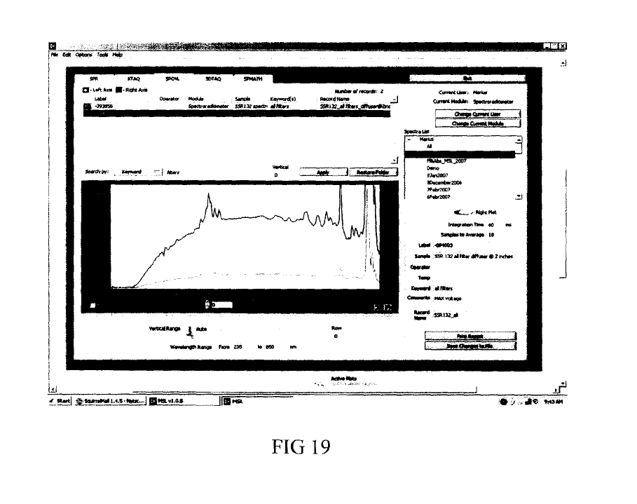

FIG. 19 is a screen capture of details in short wavelengths of the spectrum shown in FIG. 18.

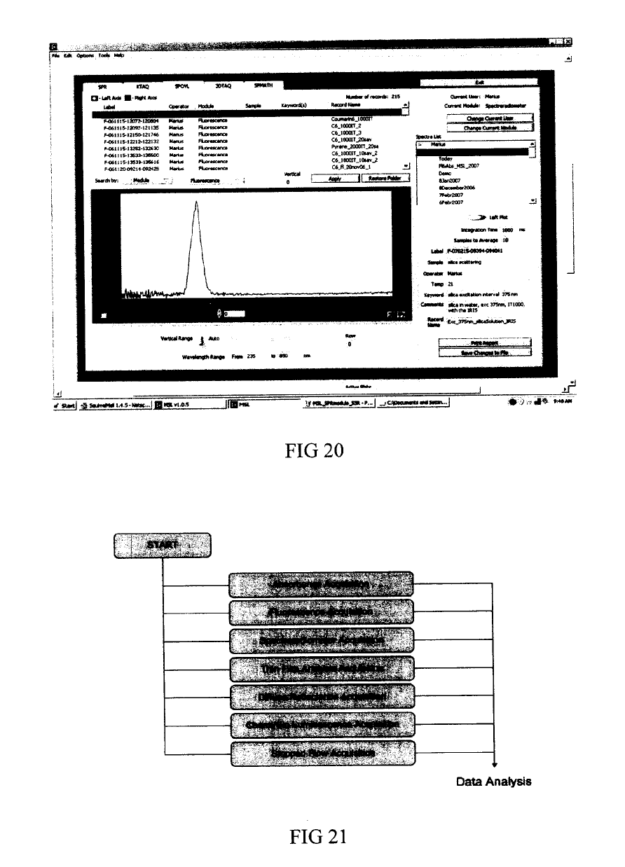

FIG. 20 is a screen capture of spectral distribution using a 375 nm extraction wavelength in the fluorescence module.

FIG. 21 is a flow chart of user selectable techniques.

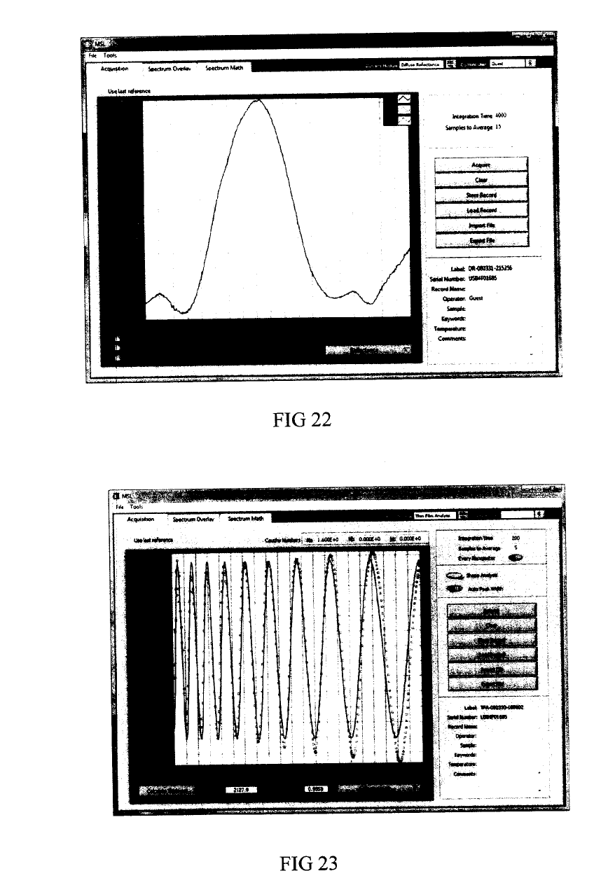

FIG. 22 is a screen capture of the reflectance spectrum for a sheet of coloured paper.

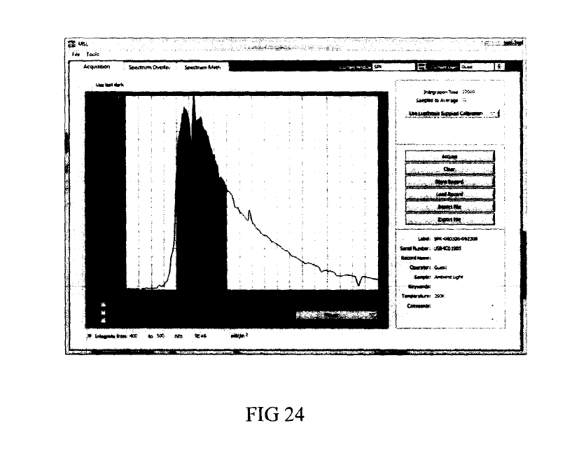

FIG. 23 is a screen capture of the thin film analysis of thin polymer.

FIG. 24 is a screen capture showing the spectroradiometer function of the present invention.

Referring now to the drawings, the overall MSL is shown in FIG. 1. The MSL is housed in a rigid case 1.

In the case is mounted a flashlamp 2, and means 3 to rotate the flashlamp. The flashlamp rotates about a vertical axis 4 near its midpoint from a first position 12, to a second position 13, as shown in FIG. 1. In the embodiment illustrated in FIG. 1, from position 1 to position 2 represents a rotation of 23.5°, but may be any angle as is appropriate for the size of case 1. Position 1 has two subpositions, 1a and 1b as shown in FIGS. 6 and 7. Flashlamp 2 is rotated by any suitable means, as will be obvious to one skilled in the art. The embodiment shown in FIG. 1 uses a drive means 5 connected to the flashlamp with a link 6. The drive means is similar to that shown in FIG. 11, which moves the filter linearly, and consists of a U-shaped frame 7 having a motor 8, preferably a stepper motor capable of incremental actuation mounted on one side thereof. The motor drives a threaded rod 9 that spans the arms 10 of the U shaped frame. Also mounted between the arms of the frame are a pair of guide rods 11, on which slides a support post 12 that may, as shown in FIG. 11, be L-shaped. Linkage 6 is rigidly connected to the post 12, and pivotably connected to the end of the lamp 2.

Where threaded rod 9 passes through post 12, post 12 is provided with a threaded base 13, so that as rod 9 is rotated by motor 8, post 12 is drawn back and forth on guide rods 11.

Also mounted in the case 1 is a bandpass filter assembly 13 that is mounted on a frame 7 as described above. Filter 14 is connected to the post 12 for movement from a first position C to a second position D as shown in FIG. 1. Filter 14 may be positioned anywhere between C and D.

A spectrometer 15, thin film analysis (TFA) lamp 16, a sample holder 17 and control board 19 are also provided. It will be understood that suitable wiring, connections, and fibre optical connectors are provided, as will be obvious to one skilled in the art.

The case 1 of the MSL is divided, moreover, into two compartments, with all components except the filter holder in a first, large, compartment (shown on the right) separated from the sample holder 17 by a rigid wall 18. The components in the large compartment are, in use, substantially sealed off from user access, and movement of components is controlled through the control board 19, which is connected to the CPU of a computer.

The sample holder 17 shown in FIG. 10, is rigidly mounted to the case 1, and includes a vertical cylindrical sample compartment 20 into which a sample, contained in a quartz cuvette may be inserted. The sample holder includes fibre optic light collection means aligned with the lamp in position 1a, so that light from the flash lamp will pass through the band pass filter at a selected wavelength through an aperture in wall 18 and through the sample, for collection, after which it is directed by optical fibres to the spectrometer for analysis, as shown in FIG. 6. The sample holder is also provided with a mirror so that light from the flashlamp, set in position 1b may be directed through a pin hole in wall 18, to the mirror, where it is reflected through the sample, and picked up and passed to the spectrometer for absorbance analysis, as shown in FIG. 7.

The MSL may also be used to measure diffuse reflectance, as shown in FIG. 2, by directing light from the lamp 2, set in position 2 to an optical connector which directs the light via optical cables into an integrating detector and off a sample on a rotating sample holder. The peripheral diffuse reflectance apparatus shown schematically in detail in side view in FIG. 3 is a known apparatus, produced and sold by Luzchem under the designation MSL-DR. An optical cable extends from the diffuse reflectance apparatus to the spectrometer 15.

As shown in FIG. 1 and FIGS. 4 and 5, the MSL may be used for thin film analysis. Light from the TFA lamp 16 passes through one side of a split fibre into the thin film sample, and is reflected back through the other side of the fibre, through a TFA fibre port in the sample holder on the MSL for collection by the spectrometer. The thin film sample holder per se is known in the art.

The MSL of the present invention may also be used for spectroradiometry, as shown in FIG. 8. Light from a sample source passes through the known spectroradiometer (such as Luzchem part No. 001613-2 SPR-Head) and is then collected from analysis by the spectrometer.

The capabilities of the MSL are shown graphically in FIG. 9. It will be understood, when considering the present invention that this invention deals with the development of a miniaturized modular spectroscopy laboratory (MSL) consisting of modular instrumentation to perform a variety of measurements, providing a consistent and easy user-interface, as well as a seamless file structure that would permit the use of common analysis software (kinetic studies, spectral comparisons, global analysis). Three main modules provide the engine to power a variety of spectroscopic measurements; these main modules are contained in an instrument box (i.e., case 1) as required based on the capabilities that each instrument may require when delivered, i.e., there is enough flexibility for some components not to be included. For example, the wavelength selection capability may be needed in some cases.

The technical concepts that are the subject of this invention apply to many possible selections of components. For example in the case of the excitation lamp many continuous and pulsed lamps are available. In a one-function instrument, the choice is simple, and either the best-suited for the technique or cost-efficiency are the prime considerations. In the case of the MSL the selection requires a balance of the multiple techniques, where the selection depends more heavily on the requirements of those techniques that are most challenging. For example, fluorescence is more demanding than absorption. In turn, chemiluminescence requires more sensitivity than fluorescence. Spectral balance (comparable energy at different wavelengths) is more important for absorbance and diffuse reflectance than for other techniques. Thus the descriptions that follow are not exhaustive, but just representative examples of the possible components that can be selected for MSL applications.

| Component | MSL selection | Possible alternatives |
|---|---|---|
| Excitation lamp | Perkin Elmer 20 Watt pulsed | Other pulsed lamps, such as those available from |
| | xenon lamp Flashpac model is | Hamamatsu or many continuous lamps, e.g., Luzchem's |
| | LS-1130-2 with bulb FX-1161 | xenon illuminator |
| Spectrometer | Ocean Optics USB4000 | Other suppliers including Newport. Further Ocean |
| | | Optics has models such as HR-4000 that will not be |
| | | used in basic units, but may be the selection for NIR |
| | | and chemi- or bioluminescence applications. |
| Wavelength | Linear variable filters with | A monochromator, such as Spectral Products CM110 |
| selection | excitation bandwidths around | could be used for wavelength selection the result would |
| | 20 nm | be improved spectral resolution (excitation bandwidth), |
| | | deteriorated signal-to-noise and increased cost. |
| Lamp positioning | designed lamp rotator | Commercially available optical positioners comprising |
| | | combinations of motors, mirrors and beam splitters |
| Wavelength | designed linear variable filter | Commercial robotics or monochromator (see above) |
| selection positioner | positioner | |
| Control | Combination of commercial | Commercial data acquisition systems, such as several |
| microprocessor and | microprocessor with designed | options offered by National Instruments |
| boards | control boards | |

While this invention deals primarily with hardware, its integration with software is important for the end user, and for the overall control of the system. The following chart refers to the techniques available through the MSL software. The user's selection determines the actions that follow, in order for the correct experimental technique to be implemented. Once the module is selected, Data Analysis is always available to the user, regardless of the method of acquisition of the data.

The MSL offers log in and restricted secure access, with users having to initially register (with system manager authorization). Account generation and login are conventional.

Once logged in the user selects the technique to be used from those available in any given configuration, as shown in the flow chart of FIG. 21.

The decision regarding the method to be used is made by the end user when presented with the menu as displayed below. This menu will be customized to show only the capabilities available for the hardware given the user-selected instrument configuration.

For example, if the user were to select fluorescence a number of operations need to be performed, specifically:

Excitation lamp needs to be positioned aiming at the optical system for emission detection

Wavelength selection hardware needs to be enabled and recalibrated if necessary

Lamp intensity (voltage) and detector parameters (e.g., integration time) need to be set to the correct sensitivity method

If part of the configuration, temperature should be checked and stabilized

If the measurement is of a kinetic nature excitation lamp needs to be run until it reaches stabilization

“dark” data needs to be acquired

“signal” needs to be acquired

data manipulation and display

data saved if required

The software flow chart of FIG. 12 summarizes in abbreviated form the sequence that is required for the acquisition of a fluorescence spectrum. Comparable sequences are required for all spectroscopic (but not kinetic) measurements.

This is followed by data analysis and manipulation, as illustrated in the flow chart of FIG. 13. Notice that “timed acquisition”, also referred as “kinetic acquisition” have additional hardware and software requirements. The use of an array detector (CCD miniature spectrometer) implies that in all cases of kinetic acquisition the full spectrum (rather than a single wavelength as in scanning instruments) is available for each time of acquisition. This array of data is referred as “3D” information.

### EXAMPLES

1) An example of a common combination of techniques:

### a) Absorbance

### b) Fluorescence

c) Fluorescence excitation

This combination is referred as MSL-FRET (FRET=fluorescence resonance energy transfer) is designed for users who require absorbance, emission (fluorescence) and fluorescence excitation as their key instrumental capabilities. ‘FRET’ instruments can be expanded to do thin film thickness, spectroradiometry and diffuse reflectance and all other techniques common to MSL products.

### MSL-FRET Capabilities

This instrument of the present invention allows the measurement of absorbance (transmission) for liquid samples in the 235-850 nm range and of fluorescence (or emission of any kind) in the 300-850 nm range. It allows for both spectroscopic and kinetic measurements. Its spectral capabilities include absorbance, fluorescence and fluorescence excitation. MSL-FRET is unique in that it offers a common, intuitive, user interface for all spectroscopic techniques. The data storage techniques of the present invention allow for fast easy retrieval and display of thousands of spectra, with intuitive overlays and simple spectrum arithmetic functions.

### MSL-FRET Advantages

Some key advantages characteristic of MSL-FRET instrumentation are:

Cost advantage. Many of the same components for are used absorbance and emission.

Use of a pulsed lamp reduce dramatically the time the sample is exposed to light.

The same user interface and storage modules for all techniques. This reduces operator training-time and makes spectral overlap (even different techniques) a standard feature.

Measure-now, change-your-mind later. Since the MSL captures CCD data, users are able to change measurement parameters long after the acquisition has been completed. For example, if kinetics were monitored at 500 nm at the time of acquisition, but a few months later it becomes advantageous to display data at 600 nm, the kinetic file can be retrieved and displayed it at any wavelength within the monitoring range.

Measure-now, change-your-mind later. Did a user record an excitation spectrum at a given emission wavelength, but a different one seems better? This is not a problem, just retrieve the kinetic file and display it at any wavelength within the monitoring range.

Is there a need to add a technique such as diffuse reflectance or thin film thickness? One can do this easily and in a cost effective manner because key spectroscopic components are shared.

Data structure in spectral lists allows flexible data organization. A given spectrum can be shared by multiple spectral lists without generating multiple copies, or can be readily accessed by date, keyword or topic.

Instrument sharing by multiple users is a key design feature of MSL products, not an afterthought. Easy login-logout allows users to return to their spectral lists.

User and manager levels within the user interface allow optional control of delete functions and new user additions, desirable features for compliant or educational applications.

Reduced energy consumption: Given the current growing environmental awareness, this type of innovation can contribute to a reduction of negative environmental impact.

2) Example of the acquisition and display of the absorbance and emission of a solution of the common fluorescent dye coumarin-110

Sample preparation: samples were prepared by dissolving Coumarin-110 (C110 (from Aldrich) in acetonitrile (Omnisolv, spectroscopy grade). The concentrations of the obtained solutions were as follows:
Coumarin-110 1×10⁻⁵ M and 2×10⁻⁵ M

The excitation wavelengths for fluorescence was 375 nm for coumarin-110. The samples were contained in quartz cuvettes, 1.0 cm×1.0 cm with a Teflon cap on top. The integration time for UV and Vis is specified for each file in the “Comments” box in the bottom right-corner of the screen shot (IT=integration time (ms), V=voltage, SAV=samples to average). For absorption measurements, the reference was a 1.0 cm×1.0 cm quartz cuvette containing acetonitrile.

The screen capture of FIG. 14 illustrates the user interface that allows the end user to organize data is spectral lists, while FIG. 15 shows a display of an absorbance spectrum for C110 acquired for a 1×10⁻⁵ M solution.

One important advantage that the MSL technology enables is the overlay of data obtained with different experimental techniques. For example the screen capture of FIG. 16 shows the absorbance and fluorescence spectra for C110 in a 2×10⁻⁵ M solution. In this case the left axis is used for absorbance and the right one for fluorescence. These are user selected. Fluorescence excitation wavelength was 375 nm

It should be emphasized that while the screen shots used for illustration purposes show the convenience of a single user interface for multiple techniques, the invention relates fundamentally to the ability to acquire these spectra with a single instrument. Further, in this particular example both spectra were acquired without having to reposition the sample of manually adjust any of the electronic or optical components. In this case the operator placed the sample in the sample compartment and then proceeded to acquire numerous spectra (only two illustrated) with all operations handled automatically from the MSL-lab computer. Robotics and microprocessors handle all optical and mechanical functions required.

3) Example of the acquisition and display of the absorbance and emission of a solution of anthracene, a sample requiring excellent spectral resolution.

The samples were prepared by dissolving anthracene (from Aldrich) in acetonitrile (Omnisolv, spectroscopy grade). The concentration of the solution was 4×10⁻⁵ M.

The excitation wavelength for fluorescence was 355 nm for anthracene. The samples were in quartz cuvettes, 1.0 cm×1.0 cm with a Teflon cap on top. The integration time for UV and Vis is specified for each file in the “Comments” box in the bottom right-corner of the screen shot (IT=integration time (ms), V=voltage, SAV=samples to average). For absorption measurements, the reference was a 1.0 cm×1.0 cm quartz cuvette containing acetonitrile. The spectra of anthracene shows as characteristic features well defined bands resulting from vibrational states in the ground state (fluorescence) and in the excited state (absorption) of anthracene. The screen capture of FIG. 17 demonstrates that the advantages of the MSL access to multiple techniques are achieved without loss of spectral quality, as demonstrated by the well resolved vibrational bands observed.

4) Example of the acquisition and display of radiometric data.

MSL instrumentation can acquire radiometric data with its spectroradiometer option. Just as important the system can read data from other radiometers and fully integrate it into the MSL system for a seamless display and analysis of data. For the purposes of this example we have selected data acquired with a stand alone instrument (SPR-4001 from Luzchem) but read directly into the MSL system. It illustrates the versatility of MSL instrumentation. The spectrum corresponds to solar irradiance in Ottawa, Ontario, Canada.

It is apparent from the spectrum of FIG. 18 that it would be desirable to expand the scale to see some details at shorter wavelengths. This is readily achieved by using the double axis capability of the software, and the spectrum of FIG. 19 shows the same example. Radiometry, as a default in the 235-850 nm range is a standard option in MSL-lab.

5) Example recording the excitation wavelength if the fluorescence module.

The fluorescence module selects the excitation wavelength requested by the end user by motorized displacement of a linear variable filter. The wavelength can be monitored by the MSL, and in fact is part of the self calibration procedure. The screen capture of FIG. 20 illustrates the spectral distribution obtained when the user selects 375 nm as the excitation wavelength.

FIG. 22 is a screen shot of a sample of colored paper for which its diffuse reflectance spectrum was recorded. The vertical axis displays the percent of the incident light absorbed by the sample. In order to record this spectrum a white standard (Spectralon) was recorded and a black standard consisting of a highly absorbing material (rich in carbon black) employed to construct optical dark boxes. Fifteen acquisition were averaged, each with an acquisition time of 4 seconds. Much faster acquisitions can be performed in most cases.

FIG. 23 shows an example of thin film analysis of a thin polymer sample deposited by the technique of spin coating on a silicon wafer. The reference was a bare silicon wafer. In this case the film has a thickness of 2127 nm and was determined by shape analysis, one of the two methodologies available for this application in the MSL. The other technique is referred as ‘peak analysis’. The main graph shows a specular reflectance interferogram and the calculated fit. Note that for this analysis the accuracy is determined by the position of the experimental and calculated peaks; in fact the actual amplitude is less important.

FIG. 24 illustrates the spectroradiometer function of the MS L and shows the spectrum of ambient light in Luzchem's manufacturing facility in Ottawa. The darker area shows the integration (results below plot) of an arbitrarily selected spectral region between 400 and 500 nm.

1. An instrument consisting of light sources, wavelength selection hardware, shutters, liquid and solid sample holders, motorized positioners, light sensors (including ultraviolet, visible and near infrared spectrometers), optical components (such as lenses, prisms, filters, beam splitters and optical fibers), microprocessors, computer interfaces and software, capable of performing a wide range of spectroscopic measurements, selected from absorbance, transmittance, fluorescence, fluorescence excitation, diffuse reflectance, spectroradiometry, thin film analysis (interferometry), chemiluminescence, bioluminescence, stopped flow, ultraviolet protection factor (UPF), and near-infrared detection.

2. An instrument as in claim 1, wherein selected capabilities are excluded to meet the requirements of a limited number of applications.

3. An instrument as in claim 2 wherein selected hardware is omitted to include only those required but the specific application.

4. A dedicated instrument with one capability only, but including the hardware to be readily expandable to at least two capabilities to be selected from those described in claim 1.

5. A dedicated instrument with one capability only, but including the hardware to be readily expandable to capabilities where the technology exists, but are not part of the current MSL options.

6. A dedicated instrument with one capability only, but including the hardware to be readily expandable to additional capabilities.

7. An instrument as described in claim 4, initially having two capabilities.

8. An instrument as described in claim 7, but initially having between three and eight capabilities.

9. An instrument using the technology of claim 1, but initially limited to the requirements for fluorescence resonance energy transfer (FRET) studies, specifically including absorbance, fluorescence and fluorescence excitation.

10. An instrument as claimed in claim 1, but where the wavelength selection is achieved using a monochromator.

11. An instrument as claimed in claim 1, but where the wavelength selection is achieved using filters.

12. An instrument as claimed in claim 1, but where the wavelength selection is achieved using monochromatic sources, such as special lamps, LEDs or lasers.

13. An instrument as claimed in claim 1, but where the light source has been replaced by a continuous (rather than pulsed) lamp.

14. An instrument as claimed in claim 1, but where an additional light source has been added, including lasers, LED's and continuous lamps.

15. Modules having MSL capabilities such as those in claim 1, but provided as an accessory for laser flash photolysis equipment, such as, Luzchem™ models LFP-111 and LFP 112.

16. An instrument as described in claim 1, but where the sample holder or stage is separate from the MSL unit and connected via optical cables and electrical wires, such as to provide remote sensing capabilities.

17. An instrument as claimed in claim 1 where the computer controlling the instrumentation is linked by a physical connection, or wireless, of via local networks or internet.

18. An instrument as claimed in claim 1, housed in a rigid case.

19. An instrument as claimed in claim 18, wherein the rigid case is divided into two compartments.

20. An instrument as claimed in claim 19, wherein the two compartments include a sample compartment and an instrument housing.

21. A modular spectroscopy laboratory (MSL), comprising a rigid case, a flashlamp rotatably mounted in said case; a sample holder for holding a sample of solution for analysis, and a spectrometer optically connected to said sample holder; wherein said flashlamp is positionable at least two angles relative to said sample holder.

22. A modular spectroscopy laboratory (MSL) as claimed in claim 21, wherein said sample holder includes a mirror for directing light from said flashlamp through a said sample.

23. A modular spectroscopy laboratory (MSL) as claimed in claim 22, wherein said case is divided into a first compartment containing said flashlamp and a second compartment containing said sample holder compartments by a rigid opaque wall between said flashlamp and said sample holder.

24. A modular spectroscopy laboratory (MSL) as claimed in claim 23, wherein said wall is provided with apertures at selected locations to permit light from said flashlamp to pass through said wall to said sample holder.

25. A modular spectroscopy laboratory (MSL) as claimed in claim 24 wherein said wall is provided with at least one optical port for receiving light from said flashlamp when said flashlamp is rotated to an appropriate angle, and optical fibre means are provided to carry said light from said optical port to an instrument for the measurement of diffuse reflectance in a sample.

26. A modular spectroscopy laboratory (MSL) as claimed in claim 24 wherein said MSL is provided with a lamp for thin film analysis (TFA) in said first compartment, and an optical post adjacent said lamp for TFA, for receiving light from said lamp for TFA, and carrying it by optical fibres to an instrument for TFA, and from said instrument for TFA to said spectrometer.

27. A modular spectroscopy laboratory (MSL) as claimed in claim 24 wherein a bandpass filter is provided in said first compartment, between said flashlamp and said sample holder, said filter being movable to select a desired wavelength of light to pass from said flashlamp to said sample holder.

28. A modular spectroscopy laboratory (MSL) as claimed in claim 27 wherein said filter is provided with a shutter to prevent passage of light from said flashlamp through a selected aperture in said rigid wall to said sample holder.

29. A modular spectroscopy laboratory (MSL) as claimed in claim 24, further comprising motor means for moving said flashlamp and said bandpass filter to any desired position.

30. A modular spectroscopy laboratory (MSL) as claimed in claim 9, wherein said motor means comprise stepper motors operably linked to said flashlamp and bandpass filter.

31. A modular spectroscopy laboratory (MSL) as claimed in claim 9, wherein the components of said MSL are operably connected to a control board accessible via a computer by a user for selected actuation operation of movement, as desired by a user.
